(19) United States
(12) Patent Application Publication
(10) Pub. No.: US 2007/0121908 A1
(43) Pub. Date: May 31, 2007

(54) Methods, systems, and computer program products for providing address translation using subsequent address information

(75) Inventors: Robby D. Benedyk, Angier, NC (US); Amrit P. S. Wadhwa, Cary, NC (US); Mahesh Tomar, Morrisville, NC (US); Jonathan J. Palmer, Durham, NC (US); Peter J. Marsico, Chapel Hill, NC (US)

Correspondence Address: JENKINS, WILSON, TAYLOR & HUNT, P. A., 3100 TOWER BLVD, SUITE 1200, DURHAM, NC, 27707, US

(73) Assignee: Tekelec

(21) Appl. No.: 11/545,789

(22) Filed: Oct. 10, 2006

Related U.S. Application Data
(60) Provisional application No. 60/724,740, filed on Oct. 7, 2005.

(51) Int. Cl. H04M 1/00; H04M 3/00

(52) U.S. Cl. 379/350

(57) ABSTRACT

Methods, systems, and computer program products for providing address translation using subsequent address information are disclosed. According to one method, a first call setup signaling message containing a first portion of a called party identifier is received. A second call setup signaling message containing a second portion of the called party identifier is received. The first and second portions of the called party identifier are used to perform an address translation.

### RELATED APPLICATIONS

This application claims the benefit of U.S. Provisional Patent Application Ser. No. 60/724,740, filed Oct. 7, 2005; the disclosure of which is incorporated herein by reference in its entirety.

### TECHNICAL FIELD

The subject matter described herein relates to providing address translation service in a communications network. More particularly, the subject matter described herein relates to methods, systems, and computer program products for providing address translation using subsequent address information.

### BACKGROUND

Number portability (NP) gives telephone service subscribers (i.e., wireline and wireless service subscribers) the ability to change local service providers without changing directory numbers. As used herein, the term “number portability” includes service provider portability, which allows subscribers to change local telephone service providers without changing directory numbers; service portability, which allows subscribers to change from one type of service to another (e.g., analog to integrated services digital network (ISDN) without changing phone numbers; geographic portability, which allows subscribers to move from one physical location to another without changing directory numbers, or any other type of service-related portability in which a subscriber desires to keep the same directory number.

While intelligent network and advanced intelligent network solutions to the problem of number portability exist, these solutions are query-and-response-based and are generally known as “triggered” number portability solutions. The implementation of triggered NP solutions typically requires network switching elements, such as end office (EO) and mobile switching center (MSC) facilities, to be upgraded to support such NP query-response functionality, which is expensive both from a financial standpoint as well as a resource management perspective. In an effort to avoid expensive network switching element upgrades, some network operators have implemented “triggerless” number portability solutions, which enable calls to be routed to ported numbers without requiring the deployment of switching-element-based NP query-response functionality. Instead, a triggerless-NP-capable network routing element, such as an Signaling System 7 (SS7) signal transfer point (STP), may intercept a call setup signaling message, such as an ISDN user part (ISUP) initial address message (IAM), extract a called party number from the message, perform a number portability translation based on the extracted called party number, modify the message to include the translated address information (e.g., a location routing number), and route the modified message to the ported destination.

One significant drawback to such traditional IAM-interception-based triggerless address translation processing is that the IAM message is relied upon to obtain the complete called party address associated with a call setup attempt. The SS7 signaling protocol provides a mechanism where call setup signaling may be initiated prior to collection of the complete called party address (e.g., dialed digit) information by the switching office originating the call. For example, once the first 6 digits of the called party address are received by an originating switching office, the switching office may generate and transmit an ISUP IAM message associated with the setup of the call, where the IAM message contains only the first 6 digits of the called party address. Once the remaining 4 digits of the called party address are collected by the originating switching office, one or more ISUP subsequent address message (SAM) messages may be used to convey the additional called party address information to other signaling nodes, so that call setup processing may be completed. In signaling environments where incomplete called party address information is included in the IAM message and one or more additional subsequent address messages are used in conjunction with the IAM message to convey called party number information, an NP translation cannot be performed for the IAM message because it lacks sufficient information for the NP lookup.

Therefore, what is needed is an address translation solution can be used in signaling environments where multiple signaling messages are used to convey called party number information associated with a call.

### SUMMARY

Methods, systems, and computer program products for providing address translation using subsequent address information are disclosed. According to one method, a first call setup signaling message containing a first portion of a called party identifier is received. A second call setup signaling message containing a second portion of the called party identifier is received. The first and second portions of the called party identifier are used to perform an address translation.

The subject matter described herein providing address translation processing may be implemented using a computer program product comprising computer executable instructions embodied in a computer readable medium. Exemplary computer readable media suitable for implementing the subject matter described herein include disk memory devices, chip memory devices, programmable logic devices, application specific integrated circuits, and downloadable electrical signals. In addition, a computer readable medium that implements the subject matter described herein may be located on a single device or computing platform distributed across multiple devices and/or computing platforms.

### BRIEF DESCRIPTION OF THE DRAWINGS

Preferred embodiments of the subject matter described herein will now be explained with reference to the accompanying drawings of which:

FIG. 1 is a block diagram illustrating an exemplary architecture of an signaling system 7 (SS7)/Internet protocol (IP)-capable signaling gateway (SG) routing node suitable for use with embodiments of the subject matter described herein;

FIG. 2 is a block diagram illustrating an exemplary internal architecture a signaling gateway that may be used to provide number portability translation service using subsequent address information according to an embodiment of the subject matter described herein;

FIG. 3 is a flow chart illustrating an exemplary process for providing number portability translation service using subsequent address information according to an embodiment of the subject matter described herein;

FIG. 4 is a block diagram illustrating an exemplary internal architecture of a call processing node for providing number portability translation service using subsequent address information according to according to an embodiment of the subject matter described herein; and

FIG. 5 is a flow chart illustrating an exemplary process for providing ENUM translation service using subsequent address information according to an embodiment of the subject matter described herein.

### DETAILED DESCRIPTION

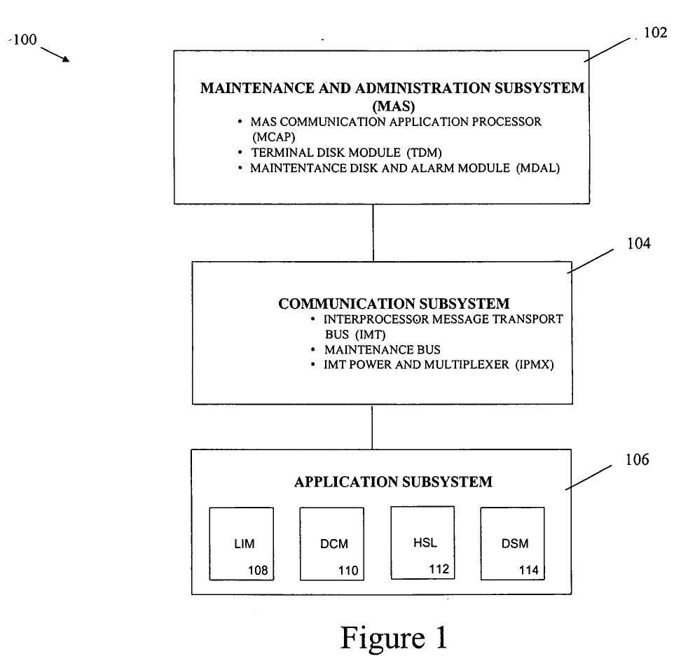

The subject matter described herein includes methods, systems, and computer program products for providing address translation using subsequent address information. Embodiments of the subject matter described herein may be implemented using an underlying hardware platform similar to that of a network routing node, such as a signal transfer point (STP) or an SS7-over-Internet protocol signaling gateway (SG). FIG. 1 is a block diagram illustrating an exemplary SG node 100, which employs a highly distributed, multi-processor system architecture suitable for use with embodiments of the subject matter described herein. As shown in FIG. 1, SG 100 includes the following subsystems: a maintenance and administration subsystem (MAS) 102, a communication subsystem 104 and an application subsystem 106. MAS 102 provides maintenance communications, initial program loading, peripheral services, alarm processing and system disks. Communication subsystem 104 includes an interprocessor message transport (IMT) bus that is the main communication bus or network in SG 100. The IMT bus facilitates communication among the various modules and subsystems in SG 100. The IMT bus may include two 1 Gbps counter-rotating serial rings.

Application subsystem 106 includes processing modules or printed circuit boards capable of communicating with the other cards through IMT bus. Numerous types of processing modules can be included in SG 100. Exemplary processing modules that may be part of application subsystem 106 include an SS7 link interface module (LIM) 108 that provides SS7 links and X.25 links, a data communication module (DCM) 110 that provides an Internet protocol (IP) signaling interface to external nodes, and a high-speed asynchronous transfer mode (ATM) communication link module (HSL) 112. A database services module (DSM) 114 may host one or more signaling message processing applications, such as global title translation, flexible routing, number portability translation, ENUM, call screening, pre-paid calling service, mobile services, 800 number service, caller identification service, and other applications that involve routing or application layer signaling message processing.

From a hardware perspective, each processing module may include an application processor and a communications processor. The application processor may perform telecommunications signaling message processing functions, such as parsing messages and performing database lookups. The communications processor on each module may control communications with other processing modules via the IMT bus.

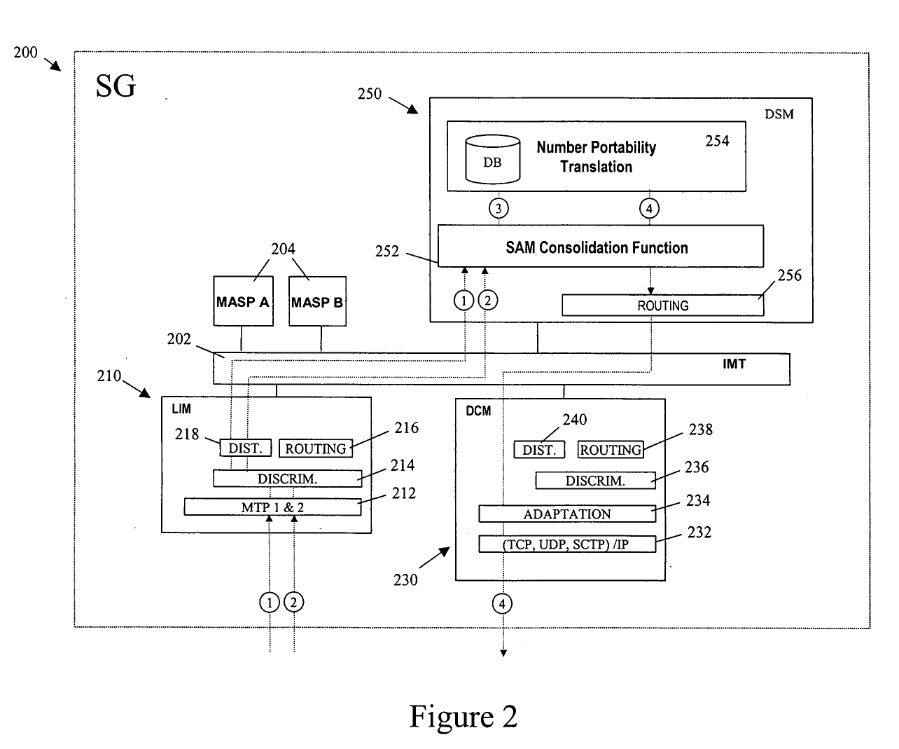

FIG. 2 illustrates an SG routing node 200, which includes a SAM-capable triggerless number portability translation system according to an embodiment of the subject matter described herein. SG routing node 200 may be a signal transfer point, a signal transfer point with SS7/IP gateway functionality, or a signal transfer point with call processing functionality. In FIG. 2, SG routing node 200 includes a high speed IMT communications bus 202 and a pair of MASP processor modules 204. MASP pair 204 implement the maintenance and administration subsystem functions described above. A number of distributed processing modules or cards may be coupled to IMT bus 202. In FIG. 2, these processing modules or cards include an SS7 LIM 210, an IP-capable DCM 230, and a DSM 250. LIM 210 may be connected to many other signaling points in a network via one or more individual signaling links, where an SS7 signaling link is typically a 56 kbps or 64 kbps DS0 link. Multiple signaling links connected to a common destination may be grouped into a virtual entity known as an SS7 signaling linkset. IP-capable DCM 230 may utilize an IP socket connection in a manner that is analogous to a signaling link or signaling linkset so as to facilitate the communication of IP-based signaling messages, such as Internet Engineering Task Force (IETF) SIGTRAN protocol messages (e.g., M3UA messages, M2PA messages, or SCTP messages), Transport Adapter Layer Interface (TALI) messages, session initiation protocol (SIP) messages, broadband ISUP (BISUP) messages, telephone user part (TUP) messages, Diameter messages, Radius messages, and CAMEL messages. Detailed descriptions of the above referenced SIGTRAN signaling protocols may be found in the following documents, the disclosure of each of which is incorporated herein by reference in its entirety:
Benedyk et al., IETF RFC 3094, “Tekelec's Transport Adapter Layer Interface,” April 2001;
Sideboftom et al., IETF Internet Draft, “SS7 MTP3 User Adaptation Layer (M3UA),” draft-ietf-sigtran-M3UA-12.txt, February 2002;
Stewart et al., IETF RFC 2960, “Stream Control Transmission Protocol (SCTP),” October 2000; and
George et al., IETF Internet Draft, “SS7 MTP2-User Peer to Peer User Adaptation Layer,” draft-ieff-sigtran-m2pa-os.txt, May 2002.

Multiple LIM, DCM, HSL, DSM and other processor modules may be provisioned and operated simultaneously within SG 200, so as to form a highly scalable, reliable message processing system.

As illustrated in FIG. 2, LIM 210 includes an SS7 MTP level 1 & 2 function 212, an SS7 MTP level 3 message discrimination function 214, a routing function 216 and a message distribution function 218. MTP level 1 and 2 function 212 provides the facilities necessary to send and receive digital data over a particular physical medium, as well as to provide error detection, error correction and sequenced delivery of SS7 messages. Message discrimination function 214 receives signaling messages from the lower processing layers and performs a discrimination operation that determines whether an incoming SS7 message is allowed into the SG system for internal processing or is simply to be through switched. Examples of received SS7 messages that require internal processing include SCCP messages in need of global title translation (GTT), ISUP, BISUP, or TUP messages requiring number portability (NP) translation service, signaling network management messages, and messages requiring other application services, as described above.

It should be noted that while embodiments of the present subject matter are described herein with respect to the ISUP signaling protocol, the subject matter described herein may be implemented for other signaling protocols, such as BISUP or TUP, that permit the communication of called party identification between signaling points using multiple signaling messages.

For received signaling messages that require MTP routing, routing function 216 is responsible for examining an incoming message received from discrimination function 214 and determining on which outbound linkset/link or signaling link equivalent (e.g., IP socket connection, etc.) the message is to be transmitted. Routing function 216 may also internally transmit the message to the outbound communication module (e.g., a LIM, a DCM, or an HSL module) associated with the selected signaling link via IMT bus 202.

If discrimination function 214 determines that a received signaling message requires processing by an internal application processor or subsystem of the SG node, then the message is passed to message distribution function 218. Message distribution function 218 is adapted to direct the signaling message to an application processor module that is equipped to provide the appropriate message processing service. For example, discrimination function 214 is responsible for examining incoming signaling messages and determining if number portability translation service is indicated. In one embodiment, NP translation service is indicated if message discrimination function 214 determines that a received signaling message is an ISUP initial address message (IAM) or subsequent address message (SAM). Such a determination may be made through examination of a service indicator (SI) parameter (e.g., ISUP SI=5) and a message type parameter within a received SS7 signaling message packet. Other SS7 message parameters, such as originating point code (OPC), destination point code (DPC), circuit identification code (CIC), and/or FCI number portability translation indicator may also be examined by discrimination function 214 in order to determine whether NP translation service is indicated for a received signaling message.

If NP translation processing is indicated for a received message, then message distribution function 218 handles the internal routing of the message to a DSM application processor module within the SG system that is provisioned with an NP translation service application.

DCM 230 includes OSI transport (e.g., TCP, UDP, SCTP), network (e.g., IP), datalink (e.g., Ethernet), and physical (e.g., TDM, SONET) layer functions, which are collectively illustrated in FIG. 2 as lower layer function 232. An adaptation function 234 enables an SS7/message transfer part (MTP) signaling message to be adapted for transport using an IP-based signaling protocol, such as an IETF SIGTRAN protocol (e.g., M3UA, SUA, etc.), transport adapter layer interface (TALI) protocol or SIP. In facilitating NP translation service using subsequent address information, DCM 230 may receive ISUP, BISUP, or TUP messages encapsulated in IP datagrams, identify messages requiring NP service, and forward the messages to the appropriate internal processing resources to receive NP translation service.

Discrimination function 236, routing function 238, and distribution function 240 associated with DCM 230 perform functions analogous to corresponding functions 214, 216, and 218, respectively, as described above with respect to LIM 210. Accordingly, if discrimination function 236 determines that a received signaling message requires processing by an internal application processor or subsystem of the SG node, then the message is passed to message distribution function 238. Message distribution function 238 may direct the signaling message to a processing module that is equipped to provide the appropriate message processing service. For example, discrimination function 236 may examine incoming signaling messages and determining if number portability translation service is indicated. In one embodiment, NP translation service is indicated if message discrimination function 236 determines that a received signaling message is an ISDN user part (ISUP) initial address message (IAM) or subsequent address message (SAM). Such a determination may be made through examination of a service indicator (SI) parameter (e.g., ISUP SI=5) and a message type parameter within a received IETF SIGTRAN M3UA signaling message packet. Other M3UA message parameters, such as originating point code (OPC), destination point code (DPC), circuit identification code (CIC), and/or FCI number portability translation indicator may also be examined by discrimination function 236 in order to determine whether NP translation service is indicated for a received signaling message. If NP translation processing is indicated for a received message, message distribution function 240 handles the internal routing of the message to a DSM application processor module within the SG system that is provisioned with an NP translation service application.

### SAM-Enabled Number Portability Application

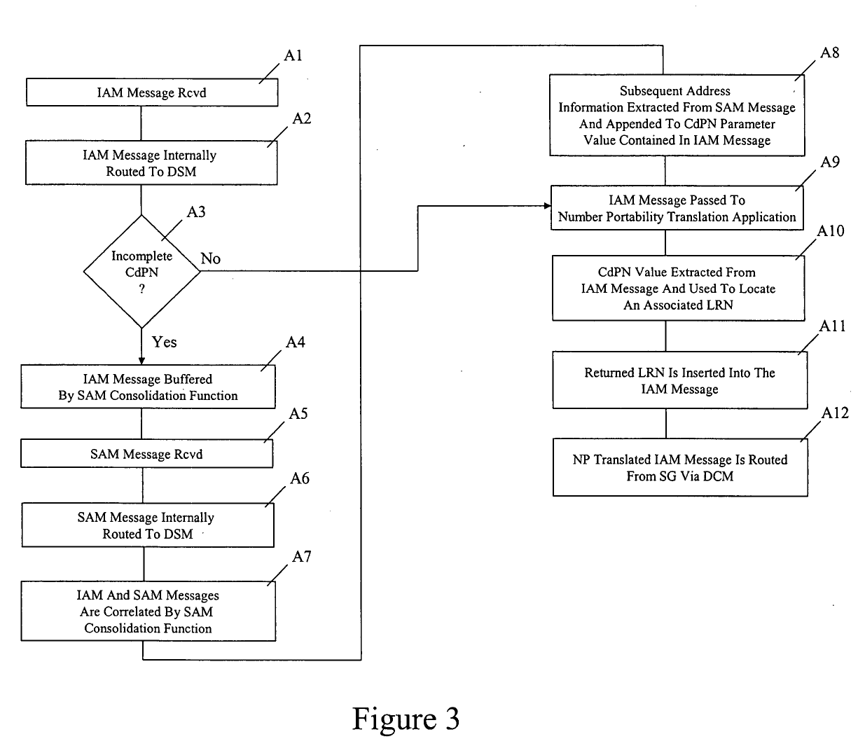

Also illustrated in FIG. 2 is an exemplary DSM 250 that is adapted to provide SAM-enabled number portability translation service. In the illustrated example, DSM 250 includes a SAM consolidation function 252, a number portability database application 254, and a routing function 256. FIG. 2 also illustrates several internal message flow paths, numbered 1 through 4, which are referred to in the description that follows. An associated processing flow diagram presented in FIG. 3 may be used in conjunction with FIG. 2 to better illustrate exemplary SAM-enabled number portability translation service.

SAM consolidation function 252 may receive an ISUP message, such as an IAM or SAM message, from a communication module, such as LIM 210 or DCM 230 (steps A1 and A2). The ISUP message may be MTP-formatted or may be formatted according to an IP adaptation protocol, such as IETF SIGTRAN M3UA or TALI. SAM consolidation function 252 may examine a message type indicator contained within the received ISUP message in order to identify the type of the received message (e.g., IAM or SAM). If the message is determined to be an IAM message (flow path 1), SAM consolidation function 252 may examine called party number (CdPN) information contained in the message in order to determine if a complete called party number is contained in the message (step A3). In this example, the CdPN parameter of the received IAM message has a value of 919380.

If it is determined that a complete called party number is contained in the IAM message, then the IAM message is passed to NP database application 254, where number portability translation processing is performed using the CdPN value contained in the IAM message (step A9). If it is determined that an incomplete called party number is contained in the IAM message, as is the case in this example, then the IAM message is temporarily buffered by SAM consolidation function 252 (step A4), and an entry associated with the IAM is placed in a correlation table. Exemplary IAM-SAM correlation data is shown below in Table 1.

TABLE 1
Exemplary IAM - SAM Correlation Data

| | | Buffer | Time |
|---|---|---|---|
| OPC | CIC | Location | Stamp |
| 1-1-1 | 56 | 12445 | 10:12:59 |
| 1-1-2 | 12 | 12446 | 10:12:58 |

In this example, the received IAM message includes an OPC parameter value of 1-1-1 and a CIC value of 56, and the IAM message is temporarily buffered in a storage array at storage array location 12445. A buffer location/storage array location may be, for example, a random access memory location, a storage array pointer value, or a database record identifier.

Continuing with the example of an ISUP IAM message that contains incomplete called party number information, once the IAM is buffered and an entry is placed in the IAM-SAM correlation table, SAM consolidation function 252 may examine incoming ISUP messages in an effort to locate one or more ISUP SAM messages that are associated with the buffered IAM message. If an ISUP SAM message is received at LIM 210 or DCM 230 (step A5), the SAM message is internally routed to DSM 250 for NP translation processing (step A6, flow path 2) in a manner similar to the handling of an IAM, as described above.

In one implementation, SAM consolidation function 252 may maintain a timer (T7) that runs while collecting all digits. The timer T7 may run from the reception of the IAM. SAM consolidation function 252 may also maintain an inter-SAM timer (T10), in case more than one SAM is required. The timer T10 is restarted each time digits are received. If either T7 or T10 expire, the action taken may depend on the numbering plan being used in the network. If it can be determined that insufficient digits are present to complete the call, a release (REL) is sent to the originator to tear down the transaction. If the number of digits might be enough (for example, a variable digit numbering plan), then the IAM is sent on to processing with whatever digits are present

Assuming that T7 or T10 has not expired, SAM consolidation function 252 receives the SAM message and examines an OPC parameter value and a CIC parameter value contained in the message. The OPC and CIC values extracted from the SAM message may be used to search the IAM-SAM correlation table (step A7). If a matching entry is located, the buffer location value associated with the matching correlation table entry is used to retrieve the associated IAM message from the temporary buffer storage. Subsequent number information may be extracted from the SAM message and appended to the incomplete called party number information contained in the IAM message (step A8). In this example, the subsequent number parameter contained in the received SAM message has a value of 3814. A check is then performed to determine whether the resulting called party number value (i.e., 9193803814) represents a complete called party number. The determination as to whether the called party number represents a complete called party number may be made based on a number of called party digits received and a numbering plan used in a network. If the resulting called party number value does represent a complete called party number, then the modified IAM message (which now includes the complete called party number information) is passed to NP database application 254, where number portability translation processing is performed using the complete CdPN value contained in the modified IAM message (step A9, flow path 3). The corresponding entry in the IAM-SAM correlation table is deleted and the buffer is cleared of the original IAM. Exemplary number portability translation data is presented in Table 2, below. In this example, the complete called party number, 9193803814, is used to search the number portability translation database and locate an associated location routing number (LRN), which identifies the switching office that is serving the ported number/subscriber (step A10). The LRN value is inserted into the IAM message, along with the complete called party number (stored in a generic address parameter), and the modified IAM message is routed from the SG (steps A11 and A12, flow path 4).

TABLE 2
Exemplary Number Portability Data

| CdPN | LRN |
|---|---|
| 9193803814 | 9192601111 |
| 9193809100 | 9192601111 |

If it is determined that the resulting called party number value does not represent a complete called party number, then the corresponding entry in the IAM-SAM correlation table is deleted, the modified IAM message (containing the original called party number information plus the additional called party number information provided by the SAM) is temporarily buffered by SAM consolidation function 252, and a new entry associated with the modified IAM is placed in a correlation table. This process may be repeated until a complete called party number can be constructed using additional called party number information provided by one or more messages that carry subsequent address information.

In this manner, the subject matter described herein may be used to provide “triggerless” number portability translation services (e.g., wireless number portability, local number portability, etc.) in a signaling environment that includes the use of ISUP SAM messages.

### Exemplary SAM-Enabled ENUM Embodiment

The Internet Engineering Task Force (IETF) initiated the development of the E.164 Number Mapping (ENUM) system for facilitating the interconnection of communications networks that rely on telephone numbers with the communications networks that utilize the Domain Name System (DNS). In particular, the ENUM system can map a particular number referred to as an E.164 number to one or more Uniform Resource Identifiers (URIs) used in the DNS. URIs are strings of characters that identify resources such as documents, images, files, databases, e-mail addresses, web sites or other resources or services in a common structured format. A URI can include a SIP URI, an instant messaging (IM) identifier, an email address identifier, an Internet chat session identifier, and/or an IP address.

People dial E.164 numbers to complete telephone calls. If the called party uses and IP phone, such as a SIP phone, an ENUM query may be required to convert the E.164 number to a URI corresponding to the IP phone. In general, an E.164 number associated with a called party is converted to an ENUM query message format by reversing the digit order of the dialed E.164 number and appending the highest level domain e164.arpa to the end. For example, if the original E.164 number is 123-456-7890, then the corresponding ENUM query is formatted as 0.9.8.7.6.5.4.3.2.1.e164.arpa. The ENUM query is then communicated to an ENUM service application, where the ENUM service application is adapted to retrieve one or more naming authority pointer (NAPTR) records associated with the E.164 number. Each of the NAPTR records may identify at least one URI corresponding to the subscriber with the E.164 number, and one or more of the returned URI values may be subsequently used to complete call setup.

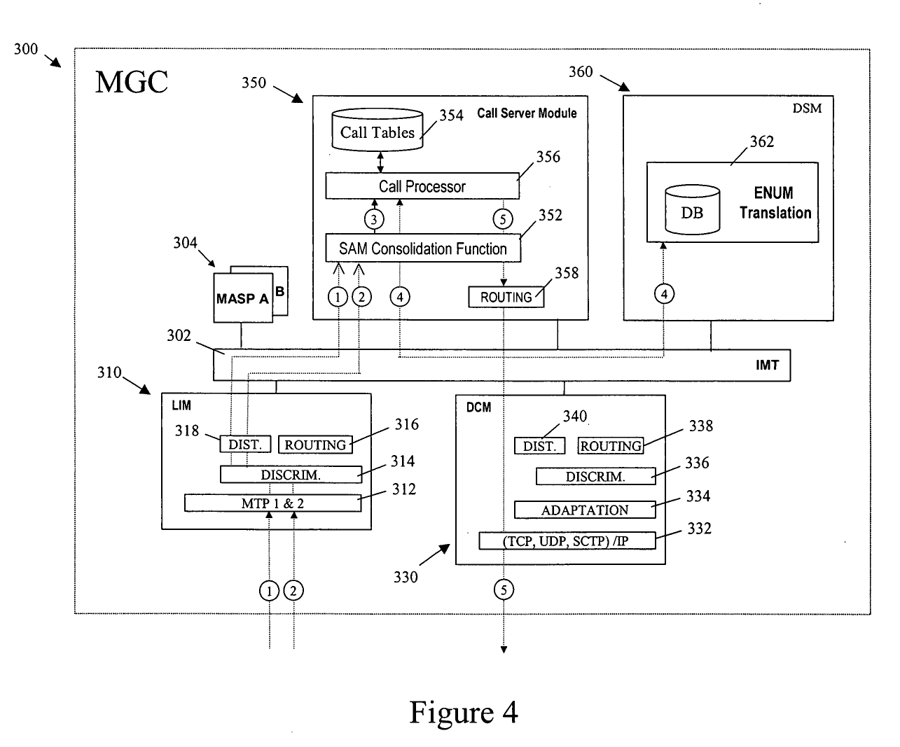

FIG. 4 is a block diagram of a call processing node 300, such as an STP that includes a media gateway controller (MGC) or softswitch (SS), that is suitable for use with one exemplary ENUM-related embodiment of the subject matter described herein. The call processing node architecture presented in FIG. 4 includes processing modules for performing signaling message routing or STP functionality, call processing or MGC functionality, and signaling gateway functionality. In the illustrated example, call processing node 300 includes “triggerless” ENUM processing functionality, in addition to this call processing functionality. As defined and described herein, triggerless ENUM processing functionality is intended to cover ENUM processing that occurs in a communications network as a result of the receipt or interception of an ISUP IAM and SAM messages.

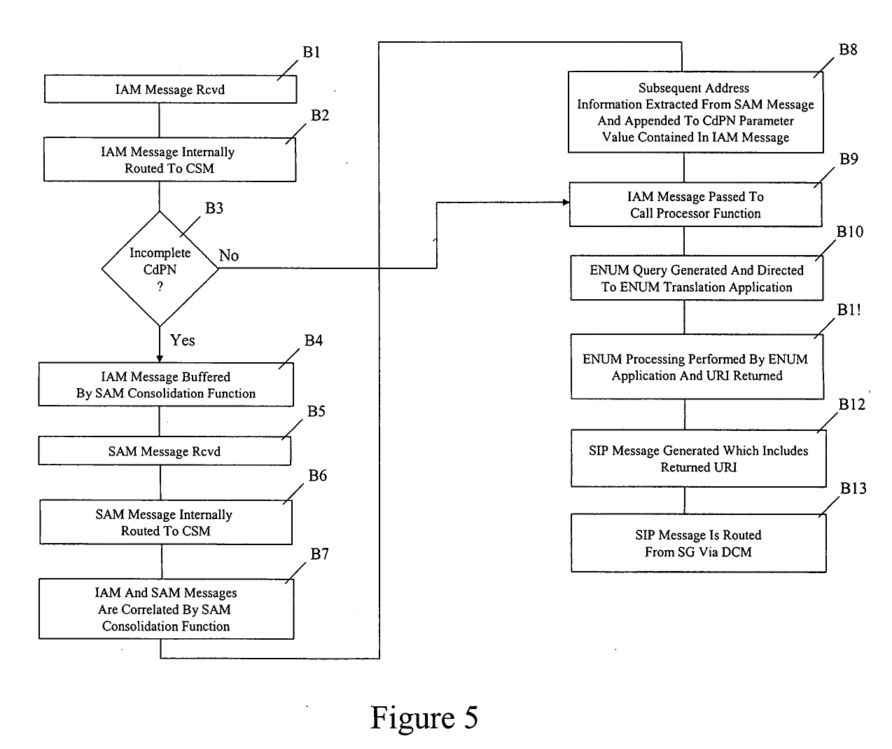

FIG. 4 also illustrates several internal message flow paths, numbered 1 through 5, which are referred to in the description that follows. An associated processing flow diagram presented in FIG. 5 may be used in conjunction with FIG. 4 to better illustrate exemplary SAM-enabled ENUM translation service.

One embodiment of a call processing node 300 which includes SAM-enabled ENUM functionality, includes a plurality of communication and/or processor cards that are connected to each other via interprocessor message transport (IMT) bus 302. Exemplary cards or processor modules include a pair of MASP processor modules 304, an SS7 link interface module (LIM) 310, an IP-capable DCM module 330, a call server module 350, and an ENUM service application processor module 360.

Bus 302, MASP processors 304, SS7 LIM module 310, and IP-capable DCM module 330 provide services and perform functions similar to those analogous components described above with respect to SG 200. IMT bus 302 provides a path for communication between processor modules in the system. SS7 LIM 310 may send and receive SS7 signaling messages to and from SS7 signaling points in a communications network. LIM 310 includes an SS7 MTP level 1 & 2 function 312, an SS7 MTP level 3 message discrimination function 314, a routing function 316, and a message distribution function 318. MTP level 1 and 2 function 312 provides the facilities necessary to send and receive digital data over a particular physical medium, as well as to provide error detection, error correction and sequenced delivery of SS7 messages. Message discrimination function 314 receives signaling messages from the lower processing layers and performs a discrimination operation that determines whether an incoming message is allowed into the MGC system for internal processing or whether the message is to be through-switched (i.e., routed to a destination without internal processing). Examples of received messages that require internal processing include ISUP messages.

For received signaling messages that require MTP routing, routing function 316 is responsible for examining an incoming message received from discrimination function 314 and determining on which outbound linkset/link or signaling link equivalent (e.g., IP socket connection, etc.) the message is to be transmitted. Routing function 316 may also internally transmit the message to the outbound communication module (e.g., LIM, DCM, HSL) associated with the selected signaling link via IMT bus 302.

If discrimination function 314 determines that a received signaling message requires processing by an internal application processor or subsystem of the MGC node, then the message is passed to message distribution function 318. Message distribution function 318 may direct the signaling message to an application processor module that is equipped to provide the appropriate message processing service. For example, discrimination function 314 may be responsible for examining incoming signaling messages and determining if call server processing is indicated. In one embodiment, call server processing is indicated if message discrimination function 314 determines that a received signaling message is an ISDN user part (ISUP) initial address message (IAM) or subsequent address message (SAM). Such a determination may be made through examination of a service indicator (SI) parameter (e.g., ISUP SI=5) and a message type parameter within a received SS7 signaling message packet. Other SS7 message parameters, such as originating point code (OPC), destination point code (DPC), and a circuit identification code (CIC) may also be examined by discrimination function 314 in order to determine whether call server processing is indicated for a received signaling message. If call server processing is indicated for a received message, then message distribution process 318 handles the internal routing of the message to a call server application processor module within the MGC system that is provisioned with a call server application.

DCM 330 includes OSI transport (e.g., TCP, UDP, SCTP), network (e.g., IP), datalink (e.g., Ethernet), and physical (e.g., TDM, SONET) layer functions, which are collectively illustrated in FIG. 4 as lower layer function 332. An adaptation function 334 enables an SS7/message transfer part (MTP) signaling message to be adapted for transport using an IP-based signaling protocol, such as an IETF SIGTRAN protocol (e.g., M3UA, SUA, etc.), a transport layer interface layer interface (TALI) protocol, or SIP. Discrimination function 336, routing function 338, and distribution function 340 associated with DCM 330 perform functions analogous to corresponding functions 236, 238, and 240, respectively, as described above with respect to DCM 230. Accordingly, if discrimination function 336 determines that a received signaling message requires processing by an internal application processor or subsystem of the MGC node, then the message is passed to message distribution function 338. Message distribution function 338 may direct the signaling message to a processing module that is equipped to provide the appropriate message processing service. DCM module 330 may also communicate with a media gateway node using media gateway control signaling messages, such as MEGACO or MGCP messages.

Call server module (CSM) 350 includes processes and databases for performing call control related functions. For example, call server module 350 may include one or more databases for performing trunk selection based on parameters in a received ISUP message. Call server module 350 may also store call state information, such as the sequence of ISUP messages received for a given call. Call server module 350 includes a SAM consolidation function 352, one or more call tables 354 for maintaining call state information and setting up a connection using a media gateway, and call processor function 356.

SAM consolidation function 352 may receive an ISUP message, such as an IAM or SAM message, from a communication module, such as LIM 310 or DCM 330 (steps B1 and B2). The ISUP message may be MTP-formatted or may be formatted according to an IP adaptation protocol, such as IETF SIGTRAN M3UA or TALI. SAM consolidation function 352 may examine a message type indicator contained within the received ISUP message in order to identify the type of the received message (e.g., IAM or SAM). If the message is determined to be an IAM message (flow path 1), SAM consolidation function 352 may examine called party number (CdPN) information contained in the message in order to determine if a complete called party number is contained in the message (step B3). Using the same example described above, the CdPN parameter of the received IAM message has a value of 919380.

If it is determined that a complete called party number is contained in the IAM message, then the IAM message is passed to call processor function 356, where number call server processing is performed using the CdPN value contained in the IAM message (step B9). If it is determined that an incomplete called party number is contained in the IAM message, as is the case in this example, then the IAM message is temporarily buffered by SAM consolidation function 352 (step B4), and an entry associated with the IAM is placed in a correlation table, such as Table 1 described above.

Continuing with the example of an ISUP IAM message that contains incomplete called party number information, once the IAM is buffered and an entry is placed in the IAM-SAM correlation table, SAM consolidation function 352 may examine incoming ISUP messages in an effort to locate one or more ISUP SAM messages that are associated with the buffered IAM message. If an ISUP SAM message is received at LIM 310 or DCM 330 (step B5), the SAM message is internally routed to call server module 350 (step B6, flow path 2) in a manner similar to the handling of an IAM, as described above.

SAM consolidation function 352 receives the SAM message and examines an OPC parameter value and a CIC parameter value contained in the message. The OPC and CIC values extracted from the SAM are used to search the IAM-SAM correlation table (step B7). If a matching entry is located, the buffer location value associated with the matching correlation table entry is used to retrieve the associated IAM message from the temporary buffer storage. Subsequent number information is extracted from the SAM message and appended to the incomplete called party number information contained in the IAM message (step B8). In this example, the subsequent number parameter contained in the received SAM message has a value of 9100. A check is then performed to determine whether the resulting called party number value (i.e., 9193809100) represents a complete called party number. If the resulting called party number value does represent a complete called party number, then the modified IAM message (which now includes the complete called party number information) is passed to call processor function 356 (step B9, flow path 3), where call processing operations, including ENUM processing operations, are performed using the complete CdPN value contained in the modified IAM message. The corresponding entry in the IAM-SAM correlation table is deleted and the buffer is cleared of the original IAM.

If it is determined that the resulting called party number value does not represent a complete called party number, then the corresponding entry in the IAM-SAM correlation table is deleted and the modified IAM message (containing the original called party number information plus the additional called party number information provided by the SAM), is temporarily buffered by SAM consolidation function 352, and a new entry associated with the modified IAM is placed in a correlation table. This process is repeated until a complete called party number can be constructed using additional called party number information provided by one or more subsequent SAM messages.

Call tables 354 may include a translation table, a routing table, a signaling table, an endpoint table, a connection table, and a state table. In one embodiment, a translation table maps dialed digits to trunk groups, a routing table maps trunk groups to media gateways and SS7 routing sets, a signaling table maps SS7 routing sets to destination point codes and linksets. The routing and signaling tables are used to generate SS7 call signaling messages relating to a call, while the endpoint and connection tables contain information for establishing a connection in a media gateway and the state table stores call state information for each endpoint in a media gateway. Also included on call server module 350 is a routing function 358 that is adapted to route outbound signaling messages (e.g., ISUP, SIP, MGCP, and/or MEGACO messages) to the appropriate outbound communication module for transmission from the MGC node.

Call processor function 356 includes call control logic that is adapted to determine the incoming port on an associated media gateway using the OPC, DPC, and CIC codes extracted from a received ISUP IAM message, and to select a trunk group for the outgoing trunk using called party subscriber identification information (e.g., CdPN, SIP URI, etc.). According to one embodiment, prior to selecting an outgoing trunk/trunk group for a call associated with an ISUP IAM message received from SAM consolidation function 352, call processor function 356 may extract the complete called party number address (previously constructed by SAM consolidation function 352) from the IAM message, and use the complete called party number to generate an ENUM query (step BIO), such as the following:
;; Query—HEADER SECTION
;; id=41555
;; qr=0 opcode=QUERY aa=0 tc=0 rd=0
;; ra=0 ad=0 cd=0 rcode ═NOERROR
;; qdcount=1 ancount=0 nscount=0 arcount=0
;; QUESTION SECTION (1 record)
;; 0.0.1.9.0.8.3.9.1.9.e164.arpa. IN NAPTR;; ANSWER
SECTION (0 records);; AUTHORITY SECTION (0 records);;
ADDITIONAL SECTION (0 records)

As described above, an E.164 number associated with a called party is converted to an ENUM query message format by reversing the digit order of the dialed E.164 number and appending the highest level domain e164.arpa to the end. Continuing with the current example (i.e., CdPN=9193809100), the associated ENUM-formatted identifier is 0.0.1.9.0.8.3.9.1.9.e164.arpa, as shown above. The ENUM query is then routed to an ENUM service application (flow path 4), which may be located on a remote network server or which may be integrated with MGC 300. In FIG. 4, an integrated ENUM service application embodiment is illustrated, where an ENUM service application 362 resides on an application processor module, DSM 360, which is coupled to the internal communication bus 302 of MGC node 300. Consequently, in the embodiment illustrated in FIG. 4, the ENUM query message is routed internally from call server module 350 to ENUM application equipped DSM 360 via IMT bus 302. In an alternate embodiment, the ENUM query is routed to a remote ENUM server via an external communication/signaling network.

The ENUM query is received at DSM 360 by ENUM application 362. ENUM application 362 includes ENUM translation data, which is used to map an E.164 telephone number to one or more URI subscriber identifiers. Exemplary ENUM translation data is presented in Table 3.

TABLE 3
Exemplary ENUM Data

| E.164 | URI |
|---|---|
| 4.1.8.3.0.8.3.9.1.9 | joe@verizon.com |
| 0.0.1.9.0.8.3.9.1.9 | pete@tekelec.com |

ENUM application 362 is adapted to process the received ENUM query message and return an associated ENUM response message, which may include one or more URI subscriber identifiers (step B11). In this example, ENUM application 362 receives the ENUM query requesting ENUM translation for the E.164 number (919) 380-9100 and returns a SIP URI value of pete@tekelec.com, as shown in the exemplary ENUM response message below:
;; Response—HEADER SECTION
;; id=41555
;; qr=1 opcode=QUERY aa=1 tc=0 rd=1
;;ra=1 ad=0 cd=0 rcode ═NOERROR
;;qdcount=1 ancount=1 nscount=1 arcount=0
;; QUESTION SECTION (1 record)
;; 0.0.0.1.9.0.8.3.9.1.9.e164.arpa. IN NAPTR;; ANSWER
SECTION (1 records)
.0.0.0.1.9.0.8.3.9.1.9.e164.arpa. 0 IN NAPTR 5688
39270 “U” “sip+E2U” “!ˆ. *$!sip:pete@tekelec.com!”;;
AUTHORITY SECTION (1 record)
1.e164.arpa. 0 IN NS cary-c.;; ADDITIONAL
SECTION (0 records).

Call processor function 356 receives the ENUM response message, extracts a URI value from the message, and uses the URI value to make an outbound trunk group/trunk selection. Based on the URI, call processor function may generate additional signaling messages associated with the call transaction, where the signaling messages may be ISUP, broadband ISUP (BISUP), TUP, SIP, or other signaling protocols. In this example, call processor function 356 generates a SIP message, which includes the URI value and routes the SIP message from the MGC node via DCM 330 (step B12, flow path 5).

In an alternate embodiment, call processor function 356 may include or have access to an ENUM subscription table, which identifies those subscribers have ENUM service. An exemplary ENUM subscription table may include a list of subscriber identifiers, as public switched telephone service (PSTN) telephone numbers or mobile subscriber identifiers (e.g., mobile subscriber ISDN, mobile identification number), as illustrated in Table 4. In this embodiment, call processor function 356 receive an IAM message from SAM consolidation function 352, extract the CdPN value from the message, and search the ENUM subscription table using the CdPN value. If a matching entry is located in the ENUM subscription table, then an ENUM query is generated and processed as described above. If a matching entry is not located in the ENUM subscription table, then ENUM translation processing is not initiated.

TABLE 4
Exemplary ENUM Subscription Data
Subscriber ID
9193803814
9193809100

Accordingly, it will be appreciated that above described embodiment of the present subject matter provides systems and methods for providing “triggerless” ENUM service in a communications network environment where ISUP SAM messages are utilized during call setup.

It will be understood that various details of the subject matter described herein may be changed without departing from the scope of the subject matter described herein. Furthermore, the foregoing description is for purposes of illustration only, and not for the purpose of limitation.

What is claimed is:

1. A method for providing call setup signaling message address translation in a communications network, the method comprising:
(a) receiving a first call setup signaling message containing a first portion of a called party identifier;
(b) receiving a second call setup signaling message containing a second portion of the called party identifier; and
(c) using the first and second portions of the called party identifier in combination to perform an address translation.

2. The method of claim 1 wherein receiving a first call setup signaling message includes receiving an ISUP IAM message.

3. The method of claim 2 wherein the first portion of a called party identifier is contained in an ISUP called party number (CdPN) parameter.

4. The method of claim 1 wherein receiving a second call setup signaling message includes receiving an ISUP SAM message.

5. The method of claim 4 wherein the second portion of the called party identifier is contained in an ISUP subsequent number parameter.

6. The method of claim 1 wherein a called party identifier comprises a telephone number.

7. The method of claim 1 wherein using the first and second portions of the called party identifier in combination to perform an address translation includes using the first and second portions of the called party identifier in combination to perform a number portability translation.

8. The method of claim 7 wherein performing a number portability translation includes using the first and second portions of the called party identifier in combination to locate a location routing number (LRN) associated with the called party identifier.

9. The method of claim 8 including modifying the first call setup signaling message to include the LRN.

10. The method of claim 1 including modifying the first call setup signaling message to include the first and second portions of the called party identifier.

11. The method of claim 1 wherein using the first and second portions of the called party identifier in combination to perform an address translation includes using the first and second portions of the called party identifier in combination to perform an ENUM translation.

12. The method of claim 11 wherein performing an ENUM translation includes using the first and second portions of the called party identifier in combination to locate a uniform resource identifier (URI).

13. The method of claim 12 including generating a session initiation protocol (SIP) message which includes the URI.

14. The method of claim 1 wherein steps (a) through (c) are performed at a network routing node.

15. The method of claim 1 wherein steps (a) through (c) are performed at a call processing node.

16. A system for providing call setup signaling message address translation in a communications network, the system comprising:
a network node including:
(a) a communication interface for receiving first and second call setup messages associated with a call in a communications network, wherein the first call setup signaling message includes a first portion of a called party identifier and the second call setup signaling message includes a second portion of the called party identifier;
(b) a consolidation function for:
(i) receiving the first and second call setup messages from the communication interface; and
(ii) combining the first and second portions of the called party identifier; and
(c) an address translation function for receiving the combined called party identifier and using the combined called party identifier to perform an address translation.

17. The system of claim 16 wherein the first call setup signaling message includes an ISUP IAM message, and the second call setup signaling message includes an ISUP SAM message.

18. The system of claim 16 wherein the communication interface is adapted to send and receive signaling system 7 (SS7) signaling messages.

19. The system of claim 16 wherein the communication interface is adapted to send and receive Internet Engineering Task Force (IETF) SIGTRAN signaling messages.

20. The system of claim 16 wherein the consolidation function is adapted to modify the first call setup signaling message to include the first and second portions of the called party identifier.

21. The system of claim 16 wherein an address translation function includes a number portability translation application for performing number portability translation.

22. The system of claim 21 wherein the number portability translation application is adapted to use the combined called party identifier to locate a location routing number (LRN) associated with the called party identifier.

23. The system of claim 22 wherein the number portability translation application is adapted to modify the first call setup signaling message to include the LRN.

24. The system of claim 16 wherein the address translation function includes an ENUM application for performing an ENUM translation.

25. The system of claim 24 wherein the ENUM application is adapted to use the combined called party identifier to locate a uniform resource identifier (URI).

26. The system of claim 25 including a call processor function for generating a session initiation protocol (SIP) message, which includes the URI.

27. The system of claim 16 wherein the network node comprises a network routing node.

28. The system of claim 16 wherein the network node comprises a call processing node.

29. A computer program product comprising computer-executable instructions embodied in a computer-readable medium for performing steps comprising:
(a) receiving a first call setup signaling message containing a first portion of a called party identifier;
(b) receiving a second call setup signaling message containing a second portion of the called party identifier; and
(c) using the first and second portions of the called party identifier in combination to perform an address translation.

30. The computer program product of claim 29 wherein receiving a first call setup signaling message includes receiving an ISUP IAM message.

31. The computer program product of claim 30 wherein the first portion of a called party identifier is contained in an ISUP called party number (CdPN) parameter.

32. The computer program product of claim 29 wherein receiving a second call setup signaling message includes receiving an ISUP SAM message.

33. The computer program product of claim 32 wherein the second portion of the called party identifier is contained in an ISUP subsequent number parameter.

34. The computer program product of claim 29 wherein a called party identifier comprises a telephone number.

35. The computer program product of claim 29 wherein using the first and second portions of the called party identifier in combination to perform an address translation includes using the first and second portions of the called party identifier in combination to perform a number portability translation.

36. The computer program product of claim 35 wherein performing a number portability translation includes using the first and second portions of the called party identifier in combination to locate a location routing number (LRN) associated with the called party identifier.

37. The computer program product of claim 36 including modifying the first call setup signaling message to include the LRN.

38. The computer program product of claim 29 including modifying the first call setup signaling message to include the first and second portions of the called party identifier.

39. The computer program product of claim 29 wherein using the first and second portions of the called party identifier in combination to perform an address translation includes using the first and second portions of the called party identifier in combination to perform an ENUM translation.

40. The computer program product of claim 39 wherein performing an ENUM translation includes using the first and second portions of the called party identifier in combination to locate a uniform resource identifier (URI).

41. The computer program product of claim 40 including generating a session initiation protocol (SIP) message which includes the URI.

42. The computer program product of claim 29 wherein steps (a) through (c) are performed at a network routing node.

43. The computer program product of claim 29 wherein steps (a) through (c) are performed at a call processing node.
